(19) United States
(12) Patent Application Publication
(10) Pub. No.: US 2021/0012001 A1
(43) Pub. Date: Jan. 14, 2021

(54) STORAGE MEDIUM, INFORMATION PROCESSING METHOD, AND INFORMATION PROCESSING APPARATUS

(71) Applicant: FUJITSU LIMITED, Kawasaki-shi (JP)

(72) Inventors: Takuya Nishino, Atsugi (JP); Shotaro Yano, Fukuoka (JP); TAKANORI OIKAWA, Kawasaki (JP)

(73) Assignee: FUJITSU LIMITED, Kawasaki-shi (JP)

(21) Appl. No.: 16/921,647

(22) Filed: Jul. 6, 2020

(30) Foreign Application Priority Data
Jul. 11, 2019 (JP) 2019-129389

(51) Int. Cl. G06F 21/55; G06F 16/901; G06N 3/08

(52) U.S. Cl. CPC G06F 21/554; G06F 2221/034; G06N 3/08; G06F 16/9024

(57) ABSTRACT

A non-transitory computer-readable storage medium storing a program that causes a computer to execute a process, the process includes acquiring training data in which information that indicates whether or not an attack is performed from a first device to a second device is associated with each of a specific operation log from the first device to the second device and a plurality of operation logs that includes operation logs from the first device to the second device before and after the specific operation log; generating order matrix data that includes a graph structure that corresponds to each of the plurality of operation logs and an order relationship of the specific operation log and the operation logs before and after the specific operation log; and generating a machine learning model based on the training data by inputting the data of the order matrix data to a neural network.

### CROSS-REFERENCE TO RELATED APPLICATION

This application is based upon and claims the benefit of priority of the prior Japanese Patent Application No. 2019-129389, filed on Jul. 11, 2019, the entire contents of which are incorporated herein by reference.

### FIELD

The embodiments discussed herein are related to a storage medium, an information processing method, and an information processing apparatus.

### BACKGROUND

In the cyber security field or the like, an operation log between Internet Protocol (IP) addresses performed in a certain time period is individually analyzed, and it is determined whether or not the operation log is an attack. Typically, since the operation log includes an operation such as communication confirmation that is frequently performed, an operation log is thinned from all the operation logs, for example.

In recent years, attack detection or the like using machine learning or the like has been performed. For example, an operation log in a certain time period when an attack is performed, an operation log in a certain time period when an attack is not performed, or the like is collected, and a machine learning model for determining whether or not the attack is performed from the operation log is learned by using training data in which the collected operation log is set as an explanatory variable and whether or not the attack is performed is set as an objective variable.

Furthermore, a machine learning model is known that determines whether or not the attack is performed from not only a specific operation log but also from an order relationship of the operation logs. For example, to determine operations before and after the target operation, an operation log in a certain time period and operation logs in time periods before and after the certain time period are collected, and a machine learning model is learned by using training data in which an integrated log obtained by integrating these operation logs is set as an explanatory variable and whether or not the attack is performed is set as an objective variable. For example, Japanese Laid-open Patent Publication No. 2018-055580, Japanese National Publication of International Patent Application No. 2018-524735, International Publication Pamphlet No. WO 2018/66221, International Publication Pamphlet No. WO 2018/163342, or the like are disclosed as related art.

### SUMMARY

According to an aspect of the embodiments, a non-transitory computer-readable storage medium storing a program that causes a computer to execute a process, the process includes acquiring training data in which information that indicates whether or not an attack is performed from a first device to a second device is associated with each of a specific operation log from the first device to the second device and a plurality of operation logs that includes operation logs from the first device to the second device before and after the specific operation log; generating order matrix data that includes a graph structure that corresponds to each of the plurality of operation logs and an order relationship of the specific operation log and the operation logs before and after the specific operation log; and generating a machine learning model based on the training data by inputting the data of the order matrix data to a neural network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of an overall configuration of a system according to a first embodiment;

FIG. 2 is a diagram for explaining an information processing apparatus according to the first embodiment;

FIG. 3 is a diagram for explaining learning using a general integrated log;

FIGS. 4A and 4B are diagrams for explaining an example where it is difficult to make determination by using a general technology;

FIG. 5 is a diagram for explaining an example of learning performed by the information processing apparatus according to the first embodiment;

FIG. 6 is a functional block diagram illustrating a functional configuration of the information processing apparatus according to the first embodiment;

FIG. 7 is a diagram illustrating an example of an operation log stored in an operation log DB;

FIG. 8 is a diagram illustrating an example of training data stored in a first training data DB;

FIG. 9 is a diagram illustrating an example of training data stored in a second training data DB;

FIG. 10 is a diagram for explaining learning by a first learning unit;

FIG. 11 is a diagram for explaining learning by a second learning unit;

FIG. 12 is a diagram for explaining matrix transformation;

FIG. 13 is a diagram for explaining vector extraction;

FIG. 14 is a flowchart illustrating a flow of learning processing;

FIG. 15 is a flowchart illustrating a flow of determination processing; and

FIG. 16 is a diagram for explaining an exemplary hardware configuration.

### DESCRIPTION OF EMBODIMENTS

However, in the above technology, an integrated log is learned as a single operation log in which content of a plurality of operation logs mixedly exists. Therefore, even if a machine learning model learned in this way is used, it is not possible to make attack determination in consideration of an order relationship.

Furthermore, depending on a communication protocol used at the time of operation, sessions vary for each command. There is a case where a session having very few operation logs occurs. As a result, there is a case where an event occurs in which the normal operation and the attack operation are included in the same log, it is difficult to make determination, and in addition, it is not possible to make determinations for all sessions. Note that it is considered to learn all the operation logs without thinning the operation logs. However, since an amount of the operation logs becomes large, a learning time is prolonged, and to learn all the operation logs is not realistic.

Furthermore, machine learning is considered for integrating operation logs in time periods before and after a certain time period and inputting each of tensor data generated from the integrated operation log and tensor data generated from the operation log in the certain time period. However, since the tensor data is generated using a plurality of operation logs as a single operation log, similarly to the other operation log, a feature of the single operation log is learned, and it is not possible to make the attack determination in consideration of the order relationship.

In view of the above, it is desirable that the attack determination can be made in consideration of the order relationship.

Embodiments of an information processing program, an information processing method, and an information processing apparatus disclosed in the present application will be described in detail with reference to the drawings below. Note that the embodiments are not limited by these embodiments. Furthermore, the following embodiments may be appropriately combined in a range where no inconsistency occurs.

### FIRST EMBODIMENT

[Overall Configuration]

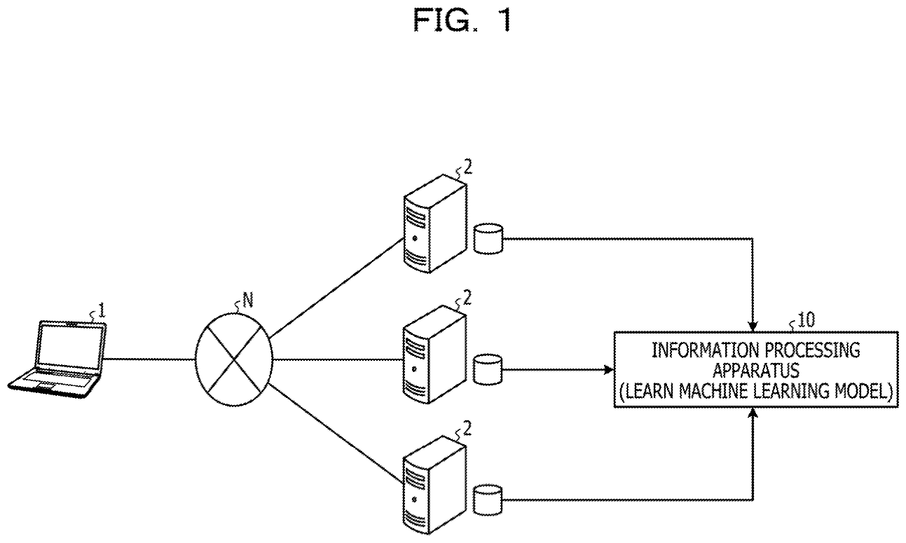

FIG. 1 is a diagram for explaining an example of an overall configuration of a system according to a first embodiment. As illustrated in FIG. 1, the system is a system that detects various attacks such as unauthorized access to a server by analyzing an operation log and includes a user terminal 1, a plurality of servers 2, and an information processing apparatus 10. The devices are connected to each other via a network N. Furthermore, an IP address is assigned to each device. Note that, as the network N, various communication networks such as the Internet or a dedicated line can be employed regardless of whether the network is wired or wireless. Furthermore, the number of user terminals 1 and the number of servers 2 are not limited to one, and the plurality of user terminals 1 and the plurality of servers 2 may be provided.

The user terminal 1 is an example of a terminal device that accesses each server 2 and, for example, is a terminal device of an authorized user that regularly accesses the server 2, a terminal device of an unauthorized user that illegally accesses the server 2 with malice, or the like. Note that, as an example of the terminal device, a personal computer, a mobile phone, a smartphone, or the like can be employed.

Each server 2 is a server device that provides various services to the user terminal 1 or the like, and each server 2 is, for example, a Web server, a database server, a file server, or the like. Furthermore, each server 2 holds history information including an access history from the user terminal 1, execution content of scripts and commands, processing content executed on the server, a state of data exchange with other terminal, and the like.

The information processing apparatus 10 is a computer device that learns a machine learning model and performs determination using a learned machine learning model, or the like. For example, the information processing apparatus 10 acquires an operation log regarding an operation performed between the user terminal 1 and each server 2 from the history information stored in each server 2 and learns a machine learning model that determines whether or not an attack is performed by using each operation log. Then, the information processing apparatus 10 performs attack determination by using the learned machine learning model.

For example, the information processing apparatus 10 extracts an operation log between IP addresses for each communication session and learns a machine learning model in consideration of an order including operation logs before and after an operation log in a certain time period. Note that the communication session is a unit of time when information is exchanged during network connection and indicates information regarding a series of operations from one terminal to another terminal.

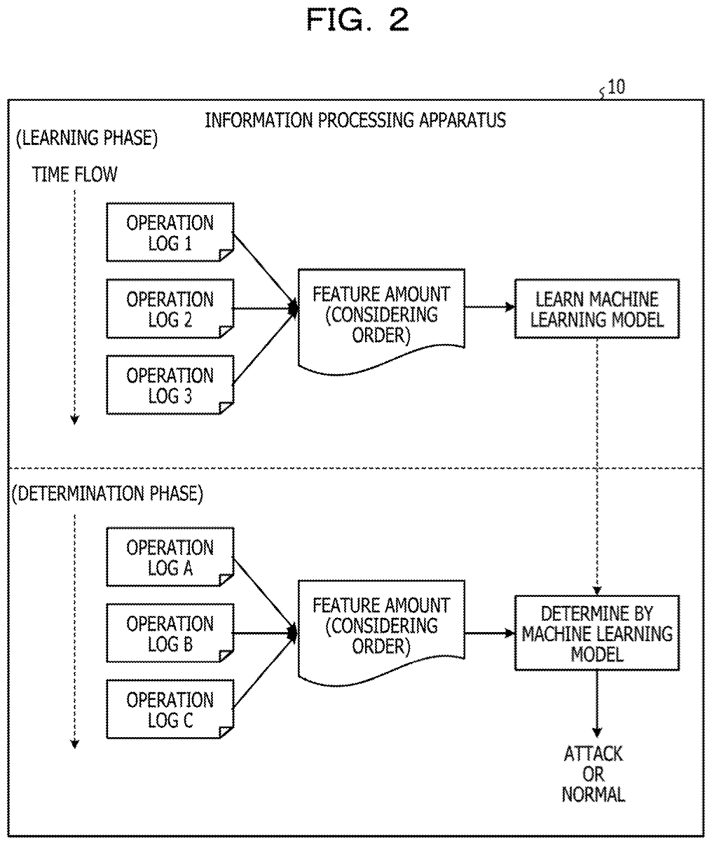

FIG. 2 is a diagram for explaining the information processing apparatus according to the first embodiment. As illustrated in FIG. 2, the information processing apparatus 10 has a learning phase and a determination phase.

In the learning phase, the information processing apparatus 10 acquires an operation log 1, an operation log 2, and an operation log 3 that are generated in respective sessions connected between the user terminal 1 and the server 2 in an order of a session 1, a session 2, and a session 3. Then, the information processing apparatus 10 generates a feature amount in consideration of an order (add order dimension) from the operation logs 1, 2, and 3. Then, the information processing apparatus 10 learns the machine learning model using a neural network or the like by using training data in which this feature amount is set as an explanatory variable and the known information indicating whether or not the attack is performed is set as an objective variable (teacher label). In this way, the information processing apparatus 10 learns the machine learning model that determines whether not an attack is performed from a flow of the series of operation logs in which whether or not an attack is performed is known.

In the determination phase, the information processing apparatus 10 acquires an operation log A, an operation log B, and an operation log C from a session to be determined and sessions before and after the session to be determined. Then, the information processing apparatus 10 generates a feature amount in consideration of an order from the operation logs A, B, and C by using a method similar to that in the learning phase and inputs the feature amount to the learned machine learning model. Thereafter, the information processing apparatus 10 determines whether the operation logs A, B, and C are an unauthorized operation including attacks to the server 2 or an authorized operation on the basis of the output result from the learned machine learning model. In this way, the information processing apparatus 10 determines whether or not the attack is performed from the flow of the series of operation logs.

[Explanation of General Technology]

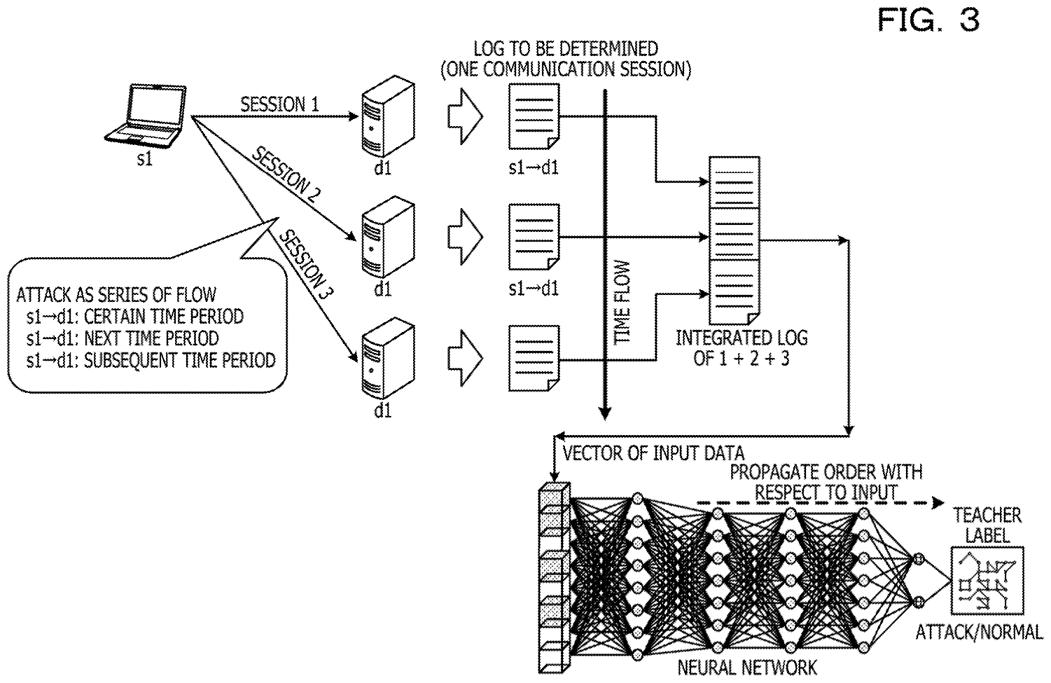

By the way, typically, learning using tensor data that is obtained by converting an integrated log, obtained by integrating a plurality of operation logs, into a tensor has been known. FIG. 3 is a diagram for explaining learning using a general integrated log. As illustrated in FIG. 3, it is assumed that, between a terminal S1 and a server d1, a session 1 be connected in a certain time period, a session 2 be connected in a next time period, and a session 3 be connected in the subsequent time period.

In this case, an integrated log integrating the operation log 1 generated in the session 1, the operation log 2 generated in the session 2, and the operation log 3 generated in the session 3 is generated. Then, a machine learning model is learned by using training data in which tensor data generated from the integrated log is set as an explanatory variable and the known information indicating whether or not the attack is performed is set as an objective variable. For example, in addition to the operation between the IP addresses to be determined, operations in sessions before and after that operation are learned.

However, it is not possible for the neural network using the tensor data to hold an order relationship in learning previous to the input data. For example, all the pieces of input data are finally vectorized before learning. Although the vectorized pieces of data have a magnitude relationship, all the pieces are used in the same way. Therefore, the order relationship is not hold after the general vectorization in machine learning. Therefore, regardless of a generation order of the operation logs, learning for determining whether or not the operation logs 1+2+3 are attacks is performed. Therefore, it is not possible to determine whether or not the operation log is an attack on the basis of the generation order of the operation logs.

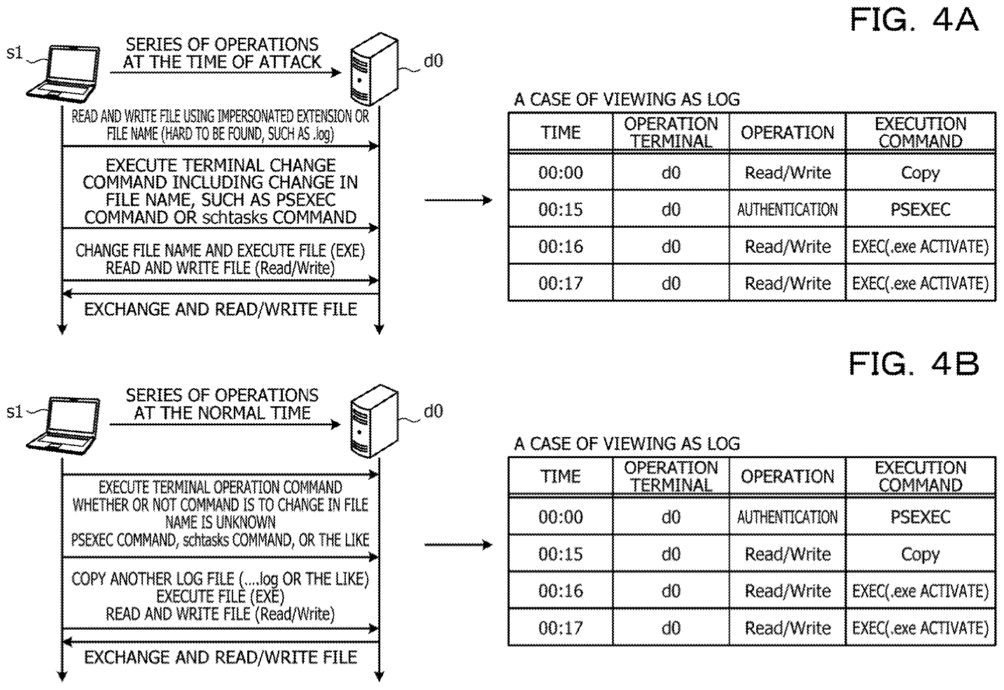

Furthermore, depending on a communication protocol used at the time of operation, sessions vary for each command. There is a case where a session having very few logs occurs. As a result, a log of which a normal operation and an attack operation are similar is caused, and there is a case where it is difficult to make determination in one session. This will be specifically described with reference to FIGS. 4A and 4B. FIGS. 4A and 4B are diagrams for explaining an example where it is difficult to make determination by using a general technology.

In FIG. 4A, a series of operations at the time of attack is illustrated, and in FIG. 48, a series of operations at the normal time is illustrated. Typically, even if an operation command is executed on the user terminal side, all the operation logs are not accurately collected due to limitations such as expansion of a memory capacity or prolonged analysis time. Therefore, there is a case where it is not possible to identify whether the executed operation command is a change in a file name or other activity, and it is difficult to identify whether the operation command is an attack or a normal operation on the operation log. By using this property, in order to avoid an operation that is easily found as an attack, there are many cases where an attacker sends an operation file and the like for infection spread using an impersonated extension, file name, or the like, and it is difficult to find such an action because the action is only file transmission.

In FIG. 4A, an attack operation from a terminal s1 to a terminal d0 is illustrated. For example, the terminal s1 reads or writes an impersonated file, as a normal operation, using an extension or the like that is frequently used. Subsequently, the terminal s1 executes a command, changes a file name, and reads or writes a file. In this case, as viewed as an operation log, an execution command (Copy) is executed on the terminal d0 at a time 00:00, and an operation of Read/Write is performed. Subsequently, an execution command (PSEXEC) is executed on the terminal d0 at a time 00:15, and an authentication operation is performed. Thereafter, an execution command (EXEC) is executed on the terminal d0 at a time 00:16 or 00:17, and the operation of Read/Write is performed on the file.

In FIG. 48, a normal operation from the terminal s1 to the terminal d0 is illustrated. For example, the terminal s1 executes an operation command such as a change in a file name on an existing file. Subsequently, the terminal s1 copies another log file, executes a file, reads or writes a file, or the like. In this case, as viewed as an operation log, the execution command (PSEXEC) is executed on the terminal d0 at a time 00:00, and the authentication operation is performed. Thereafter, the execution command (EXEC) is executed on the terminal d0 at each of times 00:15, 00:16, and 00:17, and the operation of Read/Write is performed on the file.

In this way, when the operation log in FIG. 4A that is an attack operation is compared with the operation log in FIG. 4B that is a normal operation, although the command is executed before authentication in the attack operation, the commands are similarly executed after the authentication. Furthermore, it is difficult to determine the execution of the command before the authentication as the attack operation on the operation log. For these reasons, it is difficult to determine both of the operation logs as difficult flows, and there is a case where both operation logs are determined as the same normal operation flow.

Therefore, in the first embodiment, in order to consider the relationship of the operation log generation order when learning using the tensor data is performed, a vector indicating the order relationship is extracted as a core tensor that is an example of data of a graph structure and is introduced into the neural network. With this operation, the input data is made into an order matrix (order matrix data) and is learned. As a result, learning by using the input data including the order relationship can be realized. Therefore, it is possible to make attack determination in consideration of the order relationship.

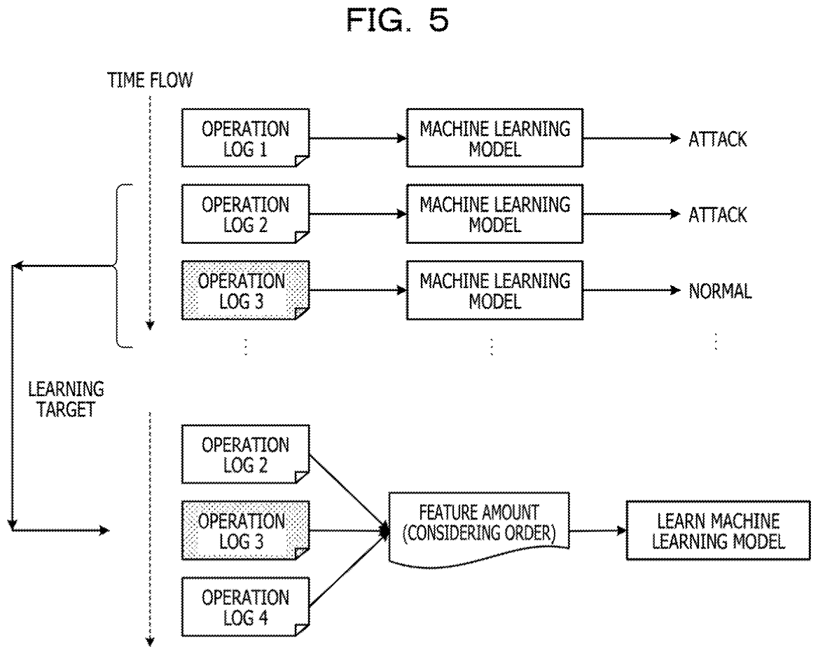

Note that, in the first embodiment, two-stage learning will be described as an example. FIG. 5 is a diagram for explaining an example of learning by the information processing apparatus 10 according to the first embodiment. As illustrated in FIG. 5, the information processing apparatus 10 learns a first machine learning model for determining whether or not an operation is an attack operation or a normal operation from a single operation log as usual, as one stage. Then, as a second stage, the information processing apparatus 10 extracts an operation log that is determined as the normal operation in the first stage and learns a second machine learning model in consideration of the order relationship.

For example, as the first stage, the first machine learning model is learned by using the operation log 1 that is an attack operation, the first machine learning model is learned by using the operation log 2 that is an attack operation, and the first machine learning model is learned by using the operation log 3 that is a normal operation. Thereafter, the operation log 3 determined as a normal operation in the first machine learning model and the operation logs 2 and 4 before and after the operation log 3 are extracted, a feature amount (order matrix) in consideration of an order relationship of these operation logs is generated, and the second machine learning model is learned by using the generated feature amount.

In the first embodiment, by performing such learning, it is possible to narrow targets of the second machine learning model. Therefore, it is possible to shorten a learning time. Note that it is possible to learn only the second machine learning model by omitting the learning at the first stage and using all the operation logs.

[Functional Configuration]

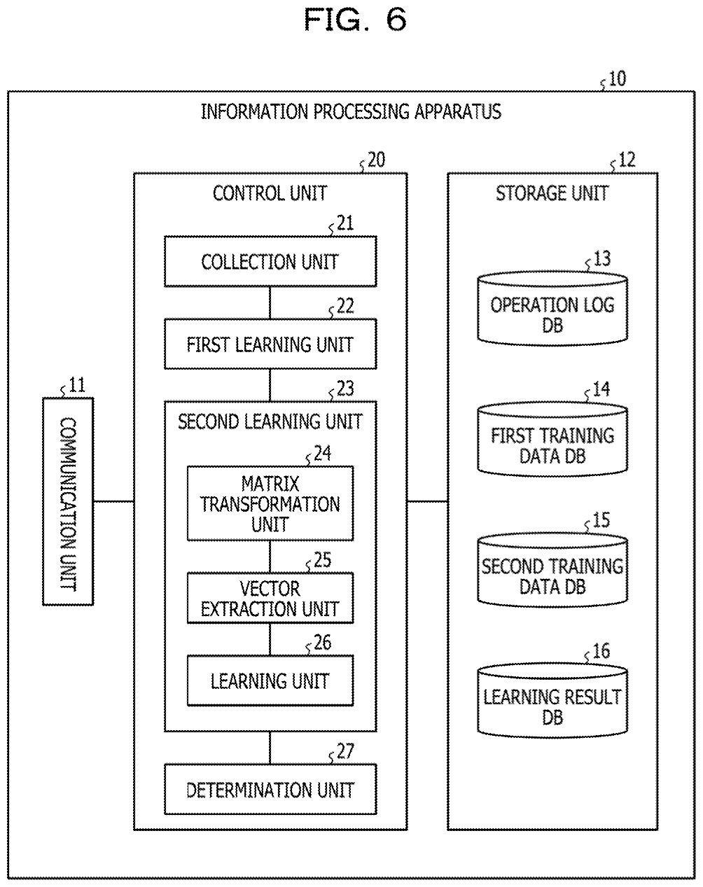

FIG. 6 is a functional block diagram illustrating a functional configuration of the information processing apparatus 10 according to the first embodiment. As illustrated in FIG. 6, the information processing apparatus 10 includes a communication unit 11, a storage unit 12, and a control unit 20.

The communication unit 11 is a processing unit that controls communication between other devices, and is, for example, a communication interface or the like. For example, the communication unit 11 acquires the operation log from each server 2 and transmits the learning result, the prediction result, or the like to a terminal used by an administrator.

The storage unit 12 is an example of a storage device that stores data and a program or the like executed by the control unit 20 and is, for example, a memory, a hard disk, or the like. The storage unit 12 stores an operation log DB 13, a first training data DB 14, a second training data DB 15, and a learning result DB 16.

The operation log DB 13 is a database that stores the operation log executed by each server 2. For example, the operation log DB 13 stores the operation logs in unit of time when information is exchanged during network connection and unit of a session indicating information regarding a series of operations from a certain terminal to another terminal.

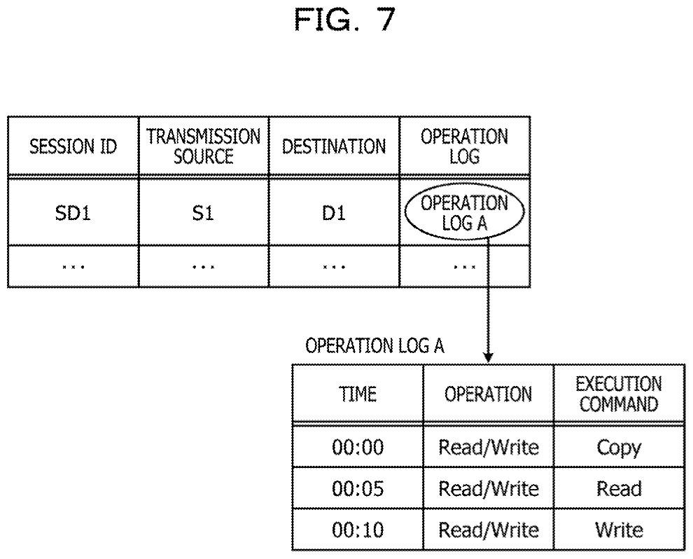

FIG. 7 is a diagram illustrating an example of the operation log stored in the operation log DB 13. As illustrated in FIG. 7, the operation log DB 13 stores “a session identification (ID), a transmission source, a destination, and an operation log” in association with each other. The “session ID” is an identifier used to identify a session. The “transmission source” indicates an execution source of the operation log, and the “destination” indicates an execution destination of the operation log. For example, the transmission source is a connection source of the session, and the destination is a connection destination of the session. The “operation log” indicates a log regarding the occurred operation. Furthermore, each item (session ID, transmission source, destination, and operation log) included in the operation log is a node when the operation log is expressed in a graph structure.

The example in FIG. 7 indicates that an operation log A is collected in a session (SD1) connected from a transmission source (SD1) to a destination (D1). The operation log A is information in which “a time, an operation, and an execution command” are associated with each other. The “time” indicates a time when the command is executed, the “operation” indicates content of the operation according to the command, and the “execution command” indicates the executed command.

The operation command A in FIG. 7 indicates that, in the session (SD1), Copy for performing Read/Write is performed at a time “00:00”, Read for performing Read/Write is performed at a time “00:05”, and Write for performing Read/Write is performed at a time “00:10”. Note that it is possible to collect the operation commands by a known method such as high-speed forensic technology.

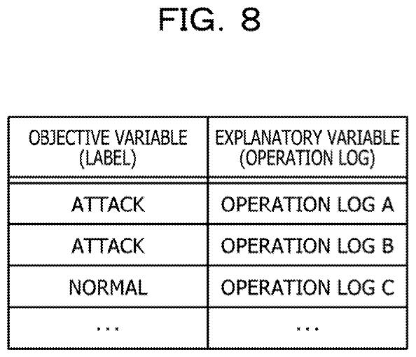

The first training data DB 14 is a database that stores training data used to learn the first machine learning model for determining whether or not the operation log is an attack by using a single operation log. FIG. 8 is a diagram illustrating an example of training data stored in the first training data DB 14. As illustrated in FIG. 8, the first training data DB 14 stores “attack, operation log A”, “normal, operation log C”, or the like as “objective variable (label), explanatory variable”.

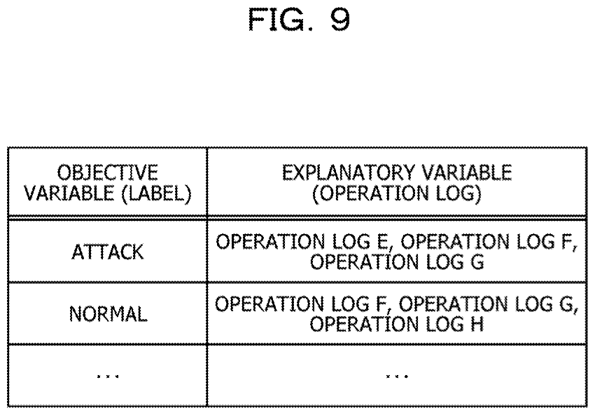

The second training data DB 15 is a database that stores training data used to learn the second machine learning model for determining whether or not the operation log is an attack by using the order relationship of the plurality of operation logs. FIG. 9 is a diagram illustrating an example of the training data stored in the second training data DB 15. As illustrated in FIG. 9, the second training data DB 15 stores “attack, operation log E, operation log F, and operation log G”, “normal, operation log F, operation log G, and operation log H”, or the like as “objective variable (label), explanatory variable”.

Here, the operation log stored as the explanatory variable is a series of operation logs including an operation log that is determined as normal according to the determination on only the operation log. For example, the series of operation logs includes an operation log in a certain time period that is determined as “normal” and operation logs before and after the operation log in the first machine learning model. For example, in a case where the operation log F at a time T is the operation log determined as “normal” in the first machine learning model, “the operation log E, the operation log F, and the operation log G” including the operation log E generated in a session at a time T−1 immediately before the operation log F and an operation log G generated in a session at a time T+1 immediately after the operation log F is included as the training data.

The learning result DB 16 is a database that stores a learning result of a first learning unit 22 and a learning result of a second learning unit 23 to be described later. For example, the learning result DB 16 stores determination results (classification result) of learning data by the first learning unit 22 and the second learning unit 23 and various parameters or the like of the NN and various parameters of deep tensor learned by machine learning or deep learning.

The control unit 20 is a processing unit that controls the entire information processing apparatus 10 and is, for example, a processor or the like. The control unit 20 includes a collection unit 21, the first learning unit 22, the second learning unit 23, and a determination unit 27. Note that the collection unit 21, the first learning unit 22, the second learning unit 23, and the determination unit 27 are examples of an electronic circuit included in a processor or examples of a process executed by a processor.

The collection unit 21 is a processing unit that collects an operation log from each server 2. For example, the collection unit 21 collects the operation logs in unit of sessions from the history information (log list) or the like stored in each server 2 and stores the collected operation log in the operation log DB 13. For example, the collection unit 21 extracts a session, an operation command, a transmission source, a destination, or the like by using the high-speed forensic technology or the like.

The first learning unit 22 is a processing unit that learns the first machine learning model that determines whether or not the operation log is an attack by using a single operation log. For example, the first learning unit 22 learns the first machine learning model, to which the tensor data is applied, by using each piece of training data stored in the first training data DB 14 and stores the learning result in the learning result DB 16.

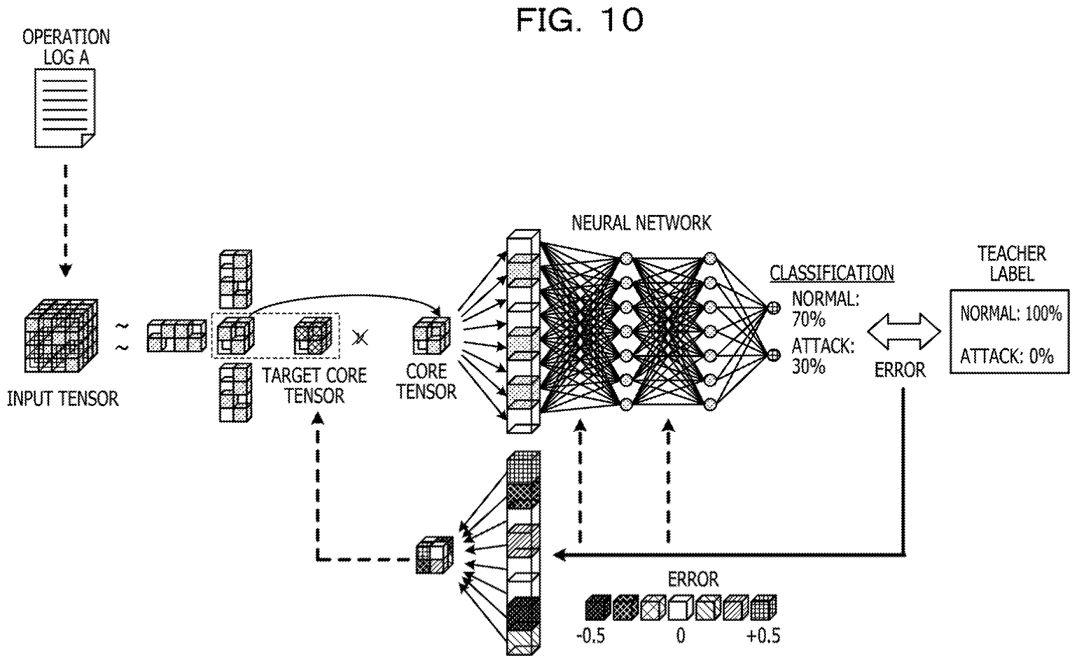

Here, learning by using the tensor data will be specifically described. FIG. 10 is a diagram for explaining learning by the first learning unit 22. As illustrated in FIG. 10, the first learning unit 22 generates an input tensor from the operation log A to which a teacher label (normal) of the normal operation that is not an attack is attached. Then, the first learning unit 22 performs tensor decomposition on the input tensor and generates a core tensor to be similar to a target core tensor generated at random at the first time. Then, the first learning unit 22 inputs the core tensor in the neural network (NN) and obtains a classification result (normal: 70%, attack: 30%). Thereafter, the first learning unit 22 calculates a classification error between the classification result (normal: 70%, attack: 30%) and the teacher label (normal: 100%, attack: 0%).

Here, the first learning unit 22 learns the machine learning model and learns a tensor decomposition method by using an extended error propagation method that is an extended error backpropagation. For example, the first learning unit 22 propagates a classification error downward to an input layer, an intermediate layer, and an output layer of the NN so as to correct various parameters of the NN to reduce the classification error. Moreover, the first learning unit 22 propagates the classification error to a target core tensor and corrects the target core tensor so as to approach a partial structure of a graph that contributes for prediction, for example, a feature pattern indicating the feature of the normal operation or a feature pattern indicating the feature of the attack operation.

Note that a determination result can be obtained by converting the input tensor into the core tensor (partial pattern of input tensor) so as to be similar to the target core tensor by tensor decomposition at the time of determination (prediction) after learning and inputting the core tensor into the neural network.

The second learning unit 23 is a processing unit that includes a matrix transformation unit 24, a vector extraction unit 25, and a learning unit 26 and learns the second machine learning model that determines whether or not the operation log is an attack by using the order relationship of the plurality of operation logs. For example, the second learning unit 23 learns the second machine learning model, to which the tensor data is applied, by using each piece of training data stored in the second training data DB 15 and stores the learning result in the learning result DB 16.

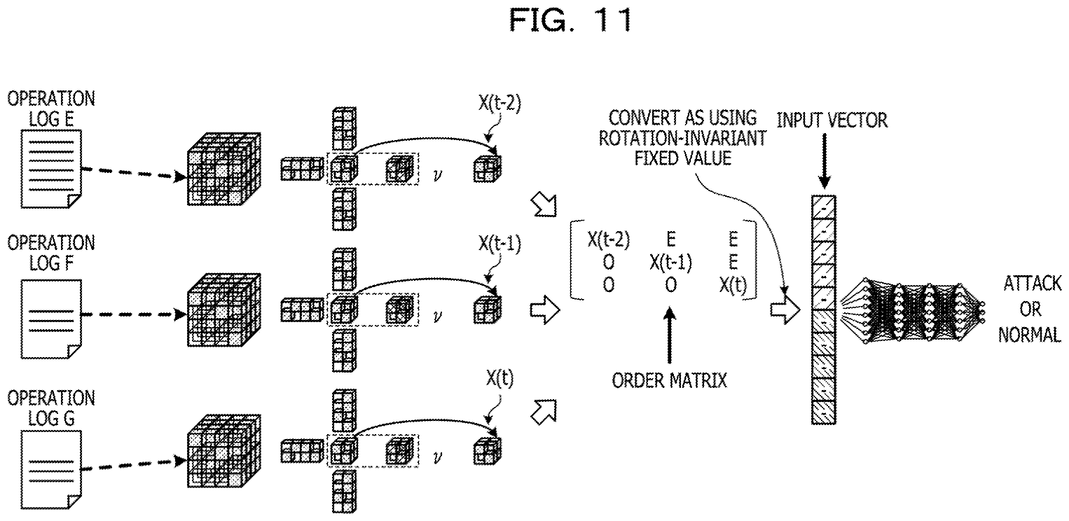

FIG. 11 is a diagram for explaining learning by the second learning unit 23. As illustrated in FIG. 11, the second learning unit 23 generates input tensors (tensor data) respectively from the operation logs E, F, and G in the explanatory variable to which the objective variable (normal) is set. Then, by generating the core tensor so that each input tensor of each operation log is similar to a target core tensor v, the second learning unit 23 generates a core tensor (X (t−2)) corresponding to the operation log E, a core tensor (X (t−1)) corresponding to the operation log F, and a core tensor (X (t)) corresponding to the operation log G for each input tensor of each operation log.

Thereafter, the second learning unit 23 generates an order matrix obtained by arranging the core tensors generated from the respective operation logs in a matrix in order to consider the order relationship of the operation logs E, F, and G. Here, zero in the order matrix indicates a zero matrix, and E indicates a unit matrix. Then, the second learning unit 23 generates an input vector by executing conversion processing using a rotation-invariant fixed value on the order matrix.

Then, the second learning unit 23 inputs the input vector to the NN and learns the machine learning model and learns the tensor decomposition method by using the extended error propagation method using the classification error between the output result from the NN and the objective variable. Here, the second learning unit 23 propagates the classification error to each target core tensor that is used when the core tensor is extracted from each operation log and corrects each target core tensor v. In this way, the second learning unit 23 updates the parameter of the NN and optimizes the target core tensor by using each piece of training data and learns the second machine learning model.

The matrix transformation unit 24 is a processing unit that converts the input data into a tensor expression. For example, the matrix transformation unit 24 acquires each operation log of the training data from the second training data DB 15, executes each processing including the matrix transformation, the tensor decomposition, and tensor merging on each operation log, generates the order matrix including the order of the operation logs as the feature amount, and outputs the order matrix to the vector extraction unit 25.

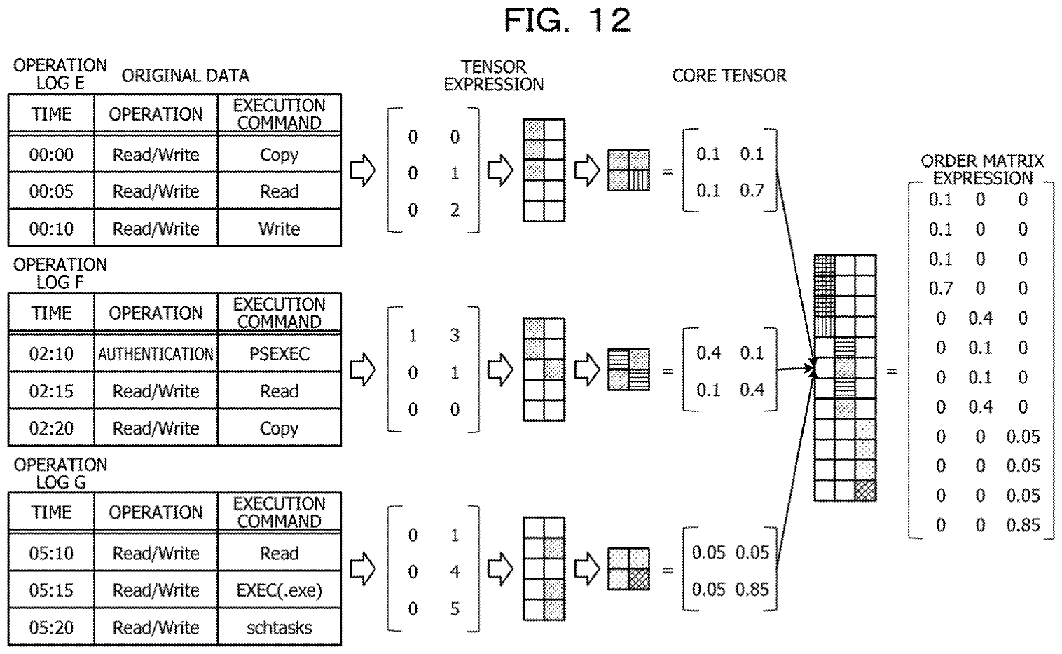

FIG. 12 is a diagram for explaining matrix transformation. As illustrated in FIG. 12, the matrix transformation unit 24 realizes the tensor expression of the input data by converting “operation, execution command” of each of the operation logs E, F, and G into a matrix. For example, the matrix transformation unit 24 converts the “Read/Write” operation into “0” and converts the “authentication” operation into “1” according to a predetermined rule, and similarly converts the execution command “Copy” operation into “0” and converts the execution command “Read” operation into “1” or the like. In this way, the matrix transformation unit 24 converts each operation log into a matrix including two rows and three columns.

Thereafter, the matrix transformation unit 24 extracts, from each matrix, a matrix that is a core tensor to be similar to the target core tensor. For example, the matrix transformation unit 24 performs general tensor 10 decomposition and generates a core tensor from each matrix. Here, the matrix transformation unit 24 converts the matrix each including two rows and three columns generated from each operation log into a matrix including two rows and two columns.

Then, the matrix transformation unit 24 merges each matrix including two rows and two columns and generates an order matrix including three rows and 12 columns. Here, in the order matrix including three rows and 12 columns, the matrix transformation unit 24 sets a matrix generated from the operation log E to a range from the first row to the fourth row in the first column, sets a matrix generated from the operation log F to a range from the fifth row to the eighth row in the second column, sets a matrix generated from the operation log G to a range from the ninth row to the twelfth row in the third column, and sets zero to the others. In this way, the matrix transformation unit 24 generates an order matrix including the feature amount of each operation log and a feature of the order relationship of the operation logs.

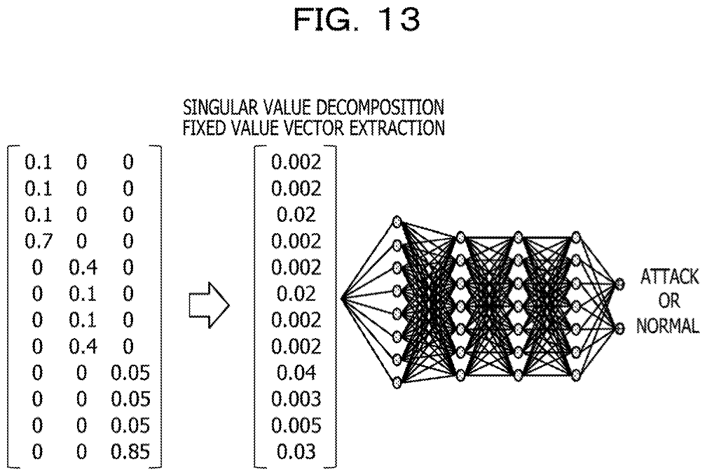

The vector extraction unit 25 is a processing unit that extracts a vector to be input to the neural network from the order matrix generated by the matrix transformation unit 24. FIG. 13 is a diagram for explaining vector extraction. As illustrated in FIG. 13, the vector extraction unit 25 acquires the order matrix including three rows and 12 columns from the matrix transformation unit 24 and performs singular value decomposition on the order matrix including three rows and 12 columns so as to extract a fixed value vector. Then, the vector extraction unit 25 outputs the extracted fixed value vector to the learning unit 26.

The learning unit 26 learns the second machine learning model that determines whether or not the operation log is an attack by using the order relationship of the plurality of operation logs by supervised learning using the fixed value vector extracted by the vector extraction unit 25. Then, the learning unit 26 stores the learning result in the learning result DB 16 when completing the learning.

For example, the learning unit 26 acquires the objective variable (label) of the training data that is a generation source of the fixed value vector from the second training data DB 15. Then, the learning unit 26 inputs the fixed value vector to a first layer of the neural network used for the second machine learning model and learns the neural network by error backpropagation on the basis of a classification error between the output result from the neural network and the objective variable.

Furthermore, the learning unit 26 performs inverse conversion by using a score of an error function of the first layer of the neural network and a left singular matrix (left singular vector) and a right singular matrix (right singular vector) in the singular value decomposition. Then, the learning unit 26 performs inverse conversion to each input tensor generated from each operation log on the basis of an index of the inversely converted matrix and updates each target core tensor so that each of the inversely transformed input tensor is similar to each target core tensor.

The determination unit 27 is a processing unit that determines whether or not the operation log is an attack by using the learning result. For example, the determination unit 27 reads the learning result of the first machine learning model and the learning result of the second machine learning model stored in the learning result DB 16 and constructs the first machine learning model and the second machine learning model.

Then, the determination unit 27 acquires an operation log to be determined and generates a core tensor from the operation log so as to be similar to the target core tensor of the first machine learning model, and inputs the core tensor to the first machine learning model (NN). Thereafter, the determination unit 27 determines that the operation log is an attack operation in a case where the output result of the first machine learning model (NN) is “attack”, and transmits the output result to the terminal of the administrator and displays the output result on a display or the like.

On the other hand, in a case where the output result of the first machine learning model is “normal”, the determination unit 27 makes determination by the second machine learning model. For example, the determination unit 27 acquires the operation logs before and after the operation log and generates the fixed value vector by the same method as the time of learning. For example, the determination unit 27 generates the input tensor from each operation log, generates the core tensor from each input tensor, and generates the order matrix in which each core tensor is merged. Then, the determination unit 27 performs the singular value decomposition on the order matrix, generates a fixed value vector, and inputs the fixed value vector to the second machine learning model (NN).

Thereafter, in a case where the output result of the second machine learning model (NN) is “attack”, the determination unit 27 determines that the operation log is an attack operation. In a case where the output result of the second machine learning model (NN) is “normal”, the determination unit 27 determines that the operation log is a normal operation, and transmits the determination result to the terminal of the administrator and displays the determination result on a display or the like.

[Flow of Learning Processing]

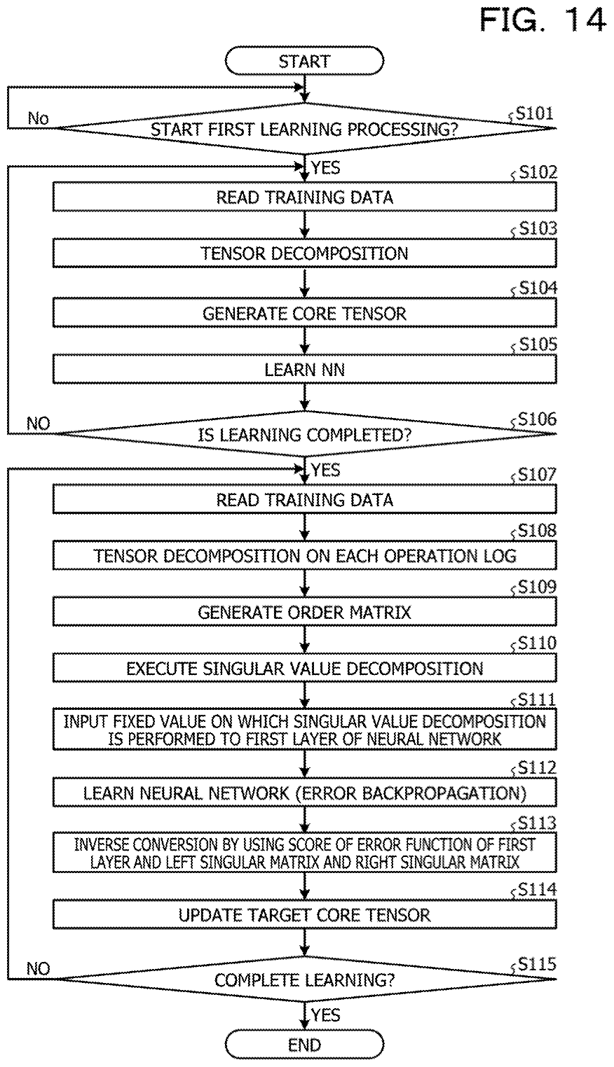

FIG. 14 is a flowchart illustrating a flow of learning processing. Note that, here, an example in which the second machine learning model is learned after learning the first machine learning model will be described. However, the embodiments are not limited to this, and learning of the first machine learning model and learning of the second machine learning model may be performed at different timings.

As illustrated in FIG. 14, when an administrator or the like instructs to start first learning processing (S101: Yes), the first learning unit 22 reads the training data from the first training data DB 14 (S102) and executes the tensor decomposition and generates an input tensor (S103).

Subsequently, the first learning unit 22 generates a core tensor from the input tensor (S104) and learns the NN of the first machine learning model (S105). Then, in a case when learning is continued (S106: No), the first learning unit 22 repeats the processing in S102 and subsequent steps. In a case where the learning is completed (S106: Yes), the processing in S107 and the processing in subsequent steps are executed.

For example, the second learning unit 23 reads the training data from the second training data DB 15 (S107) and performs the tensor decomposition on each operation log in the training data and generates the input tensor (matrix) (S108).

Subsequently, the second learning unit 23 generates a core tensor from each input tensor and generates an order matrix in which each core tensor is merged (S109). Then, the second learning unit 23 performs the singular value decomposition on the order matrix (S110), inputs (allocate) a fixed value vector, on which the singular value decomposition is performed, to the first layer of the NN (S111), and learns the NN by the error backpropagation (S112).

Thereafter, the second learning unit 23 performs inverse conversion by using a score of an error function of the first layer and the left singular matrix and the right singular matrix (S113) and updates the target core tensor by using the inversely converted matrix (S114).

Then, in a case where learning is continued (S115: No), the second learning unit 23 repeats the processing in S107 and subsequent steps, and in a case where the learning is completed (S115: Yes), the second learning unit 23 completes the processing.

[Flow of Determination Processing]

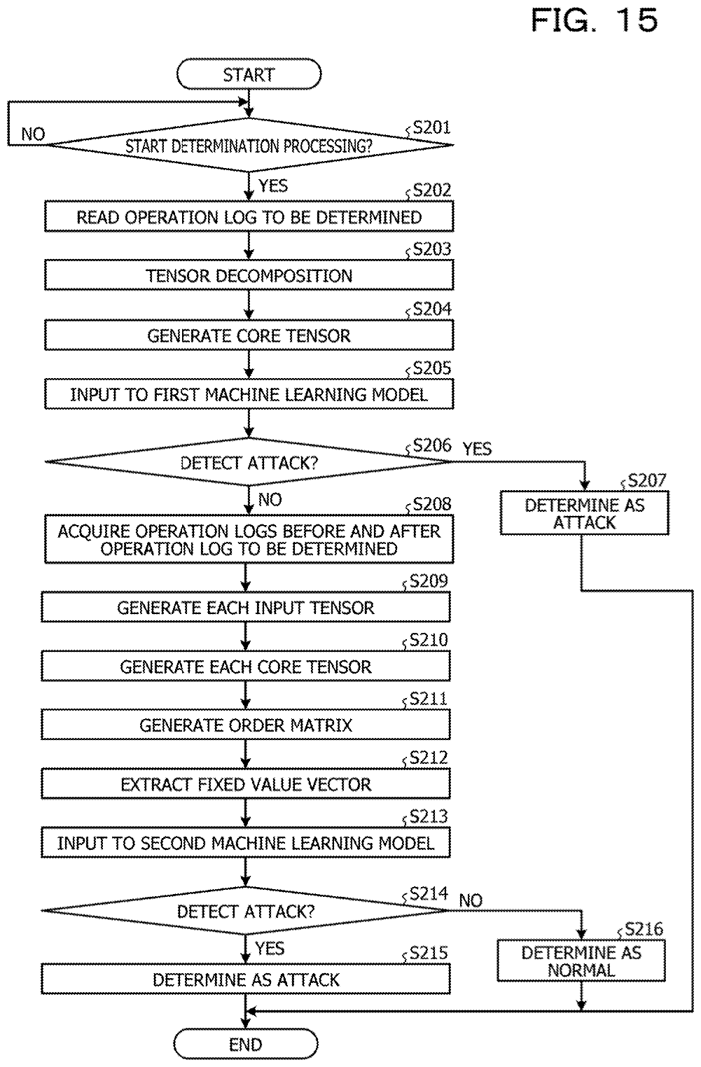

FIG. 15 is a flowchart illustrating a flow of determination processing. As illustrated in FIG. 15, when the determination processing is started (S201: Yes), the determination unit 27 acquires an operation log to be determined (S202).

Subsequently, the determination unit 27 performs the tensor decomposition and generates an input tensor from the operation log (S203) and generates a core tensor from the input tensor (S204). Then, the determination unit 27 inputs the core tensor to the learned first machine learning model (S205), and in a case where the output result indicates an attack (S206: Yes), the determination unit 27 determines that the operation log is an attack operation (S207).

In a case where the output result of the first machine learning model indicates normal (S206: No), the determination unit 27 acquires operation logs before and after the operation log to be determined (S208) and generates each input tensor from each operation log by performing the tensor decomposition (S209).

Then, the determination unit 27 generates a core tensor from each input tensor (S210), generates an order matrix by using each core tensor (S211), and generates a fixed value vector by performing the singular value decomposition on the order matrix (S212).

Thereafter, the determination unit 27 inputs the fixed value vector to the learned second machine learning model (S213). Then, in a case where the output result of the second machine learning model indicates an attack (S214: Yes), the determination unit 27 determines that the operation log is an attack operation (S215), and in a case where the output result of the second machine learning model indicates normal (S214: No), the determination unit 27 determines that the operation log is a normal operation (S216).

[Effects]

As described above, since the information processing apparatus 10 can learn the second machine learning model by the fixed value vector (input vector) in consideration of the order relationship, it is possible to make the attack determination in consideration of the order relationship, and it is possible to determine whether or not the operation log is an attack on the basis of a relationship between the operation log to be determined and the operation logs before and after the operation log to be determined.

Furthermore, the information processing apparatus 10 uses only the operation log that is not determined as an attack from a single operation log as the training data of the second machine learning model at the time of learning. Therefore, the information processing apparatus 10 can shorten the learning time while reducing a decrease in learning accuracy than a case where all the operation logs are set as training targets. Furthermore, since the information processing apparatus 10 can make determination in a stepwise manner by using the first machine learning model and the second machine learning model at the time of determination, both of quick attack detection and attack detection with no leakage can be performed.

### SECOND EMBODIMENT

Although the embodiment of the embodiments have been described above, the embodiments may be implemented in various different forms in addition to the above embodiment.

[Data, Numerical Value, or the Like]

A data example, a numerical value example, a display example, a matrix example, a dimension of a matrix, or the like used in the above embodiments are merely examples, and can be arbitrarily changed. Furthermore, the first learning unit 22, the second learning unit 23, and the determination unit 27 can be implemented by different devices. Note that, in the above embodiment, an example has been described in which three operation logs are used for the training data as a series of operation logs. However, as long as the number of operation logs is equal to or more than two, the number can be arbitrarily changed.

[Association]

In the first embodiment, a case where the operation destinations (attack target) of the series of operation logs are the same computer has been described as an example. However, the embodiments are not limited to this. Even in a case where the attack destinations can be associated with each other even if the attack destinations are different from each other, processing can be performed by using the method similar to that in the first embodiment. For example, it can be determined an operation in the session connected from the terminal s1 to the server d2 within a predetermined time, for example, ten minutes, after the operation is performed in the session connected from the same terminal s1 to the server d1 as the series of operations.

[Machine Learning Model]

In the above embodiment, an example in which the neural network is used as the machine learning model has been described. However, the embodiments are not limited to this, and other machine learning such as Recurrent Neural Network (RNN) can be adopted.

[System]

Pieces of information including the processing procedure, the control procedure, the specific name, various types of data and parameters described above in the document or illustrated in the drawings may be arbitrarily changed unless otherwise specified.

Furthermore, each component of each apparatus illustrated in the drawings is functionally conceptual and does not necessarily have to be physically configured as illustrated in the drawings. For example, specific forms of distribution and integration of the respective apparatuses are not restricted to the forms illustrated in the drawings. For example, this means that all or a part of the apparatus can be configured by being functionally or physically distributed and integrated in arbitrary units according to various sorts of loads and usage situations and the like.

Moreover, all or an optional part of each processing function performed in each apparatus may be implemented by a central processing unit (CPU) and a program analyzed and executed by the CPU, or may be implemented as hardware by wired logic.

[Hardware]

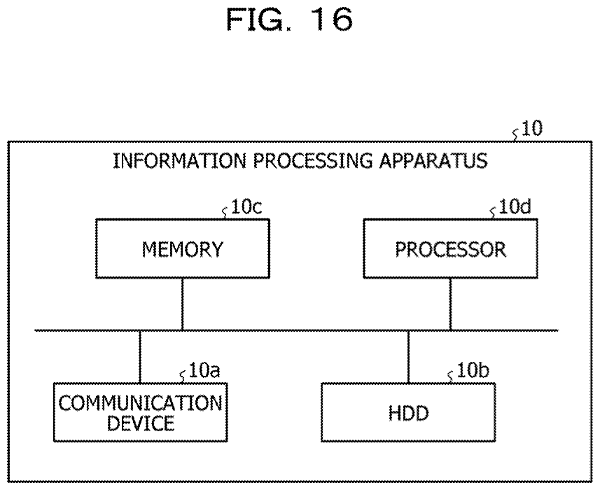

FIG. 16 is a diagram for explaining an exemplary hardware configuration. As illustrated in FIG. 16, the information processing apparatus 10 includes a communication device 10a, a Hard Disk Drive (HDD) 10b, a memory 10c, and a processor 10d. Furthermore, the units illustrated in FIG. 16 are mutually connected to each other by a bus or the like.

The communication device 10a is a network interface card or the like and communicates with other device. The HDD 10b stores a program that activates the function illustrated in FIG. 6 and a DB.

The processor 10d reads a program that executes a process similar to the process of each processing unit illustrated in FIG. 2 from the HDD 10b or the like to develop the read program in the memory 10c so as to activate a process that performs each function described with reference to FIG. 2 or the like. For example, this process performs a function similar to that of each processing unit included in the information processing apparatus 10. For example, the processor 10d reads programs having functions similar to those of the collection unit 21, the first learning unit 22, the second learning unit 23, the determination unit 27, or the like from the HDD 10b or the like. Then, the processor 10d executes a process for executing the processing similar to that by the collection unit 21, the first learning unit 22, the second learning unit 23, the determination unit 27, or the like.

In this way, the information processing apparatus 10 operates as an information processing apparatus that realizes the learning method by reading and executing the program. Furthermore, the information processing apparatus 10 can also implement functions similar to the functions of the above-described embodiments by reading the program described above from a reording medium by a medium reading device and executing the read program described above. Note that, this program that is referred in the other embodiment is not limited to being executed by the information processing apparatus 10. For example, the embodiments can be similarly applied to a case where another computer or server executes the program, or a case where such computer and server cooperatively execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
acquiring training data in which information that indicates whether or not an attack is performed from a first device to a second device is associated with each of a specific operation log from the first device to the second device and a plurality of operation logs that includes operation logs from the first device to the second device before and after the specific operation log;
generating order matrix data that includes a graph structure that corresponds to each of the plurality of operation logs and an order relationship of the specific operation log and the operation logs before and after the specific operation log; and
generating a machine learning model based on the training data by inputting the data of the order matrix data to a neural network.

2. The non-transitory computer-readable storage medium to claim 1, wherein the generating a machine learning processing includes:
inputting a fixed value vector obtained by performing singular value decomposition on the order matrix data to the neural network; and
generating the machine learning model based on a difference between an output result from the neural network and the information that indicates whether or not the attack is performed.

3. The non-transitory computer-readable storage medium according to claim 1, wherein
the computer is caused to execute processing that collects the operation log for each communication session from the first device to the second device, and
the acquiring processing acquires an operation log generated in a second session connected before a first session in which the specific operation log is collected and an operation log generated in a third session connected after the first session as the operation logs before and after the specific operation log.

4. The non-transitory computer-readable storage medium according to claim 1, wherein the generating data of an order matrix processing includes:
diagonally arranging each of data that indicates a first graph structure generated from the operation log before the specific operation log, data that indicates a second graph structure generated from the specific operation log, and data that indicates a third graph structure generated from the operation log after the specific operation log as each element; and
generating the order matrix data in which a zero matrix or a unit matrix is arranged in other element.

5. The non-transitory computer-readable storage medium according to claim 1, further comprising:
acquiring a plurality of determination target logs that includes an operation log to be determined and operation logs before and after the operation log to be determined generated in sessions before and after the operation log to be determined,
generating the data of the order matrix by using data that indicates a plurality of graph structures that respectively corresponds to the plurality of determination target logs, and
determining whether the plurality of determination target logs is an attack based on an output result obtained by inputting the order matrix data to a learned machine learning model.

6. The non-transitory computer-readable storage medium according to claim 5, further comprising:
learning a second machine learning model that determines whether an attack is performed from an operation log by using training data in which each operation log from the first device to the second device is associated with correct answer information that indicates whether each operation log falls under the attack,
causing a computer to execute processing that determines whether the attack is performed according to an output result obtained by inputting the operation log to be determined to the second machine learning model, and
wherein the determining includes:
inputting the order matrix data generated by using the plurality of determination target logs that includes the operation log to a first machine learning model learned by using the plurality of operation logs when it is determined that the attack is not performed based on an output result from the second machine learning model, and
determining whether the attack is performed based on a result from the first machine learning model.

7. An information processing method executed by a computer, the information processing method comprising:
acquiring training data in which information that indicates whether or not an attack is performed from a first device to a second device is associated with each of a specific operation log from the first device to the second device and a plurality of operation logs that includes operation logs from the first device to the second device before and after the specific operation log;
generating data of an order matrix that includes a graph structure that corresponds to each of the plurality of operation logs and an order relationship of the specific operation log and the operation logs before and after the specific operation log; and
generating a machine learning model based on the training data by inputting the data of the order matrix to a neural network.

8. The information processing method according to claim 7, wherein the generating a machine learning processing includes:
inputting a fixed value vector obtained by performing singular value decomposition on the data of the order matrix to the neural network; and
generating the machine learning model based on a difference between an output result from the neural network and the information that indicates whether or not the attack is performed.

9. The information processing method according to claim 7,
wherein the computer is caused to execute processing that collects the operation log for each communication session from the first device to the second device, and
the acquiring processing acquires an operation log generated in a second session connected before a first session in which the specific operation log is collected and an operation log generated in a third session connected after the first session as the operation logs before and after the specific operation log.

10. The information processing method according to claim 7, wherein the generating data of an order matrix processing includes:
diagonally arranging each of data that indicates a first graph structure generated from the operation log before the specific operation log, data that indicates a second graph structure generated from the specific operation log, and data that indicates a third graph structure generated from the operation log after the specific operation log as each element; and
generating the data of the order matrix in which a zero matrix or a unit matrix is arranged in other element.

11. An information processing apparatus, comprising:
a memory; and
a processor coupled to the memory and configured to:
acquire training data in which information that indicates whether or not an attack is performed from a first device to a second device is associated with each of a specific operation log from the first device to the second device and a plurality of operation logs that includes operation logs from the first device to the second device before and after the specific operation log,
generate data of an order matrix that includes a graph structure that corresponds to each of the plurality of operation logs and an order relationship of the specific operation log and the operation logs before and after the specific operation log, and
generate a machine learning model based on the training data by inputting the data of the order matrix to a neural network.

12. The information processing apparatus, according to claim 11, wherein the processor is configured to:
input a fixed value vector obtained by performing singular value decomposition on the data of the order matrix to the neural network; and
generate the machine learning model based on a difference between an output result from the neural network and the information that indicates whether the attack is performed.

13. The information processing apparatus, according to claim 11, wherein the computer is caused to execute processing that collects the operation log for each communication session from the first device to the second device,
wherein the processor is configured to acquire an operation log generated in a second session connected before a first session in which the specific operation log is collected and an operation log generated in a third session connected after the first session as the operation logs before and after the specific operation log.

14. The information processing apparatus, according to claim 11, wherein the processor is configured to:
diagonally arrange each of data that indicates a first graph structure generated from the operation log before the specific operation log, data that indicates a second graph structure generated from the specific operation log, and data that indicates a third graph structure generated from the operation log after the specific operation log as each element; and
generate the data of the order matrix in which a zero matrix or a unit matrix is arranged in other element.
